(19) United States
(12) Patent Application Publication
(10) Pub. No.: US 2009/0229112 A1
(43) Pub. Date: Sep. 17, 2009

(54) METHOD OF PRODUCING HEAD SLIDER

(75) Inventors: Masayuki Hamakawa, Kawasaki (JP); Mitsuru Kubo, Kawasaki (JP); Satoshi Tomita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/235,218

(22) Filed: Sep. 22, 2008

(30) Foreign Application Priority Data
Mar. 17, 2008 (JP) 2008-067359

(51) Int. Cl. G11B 5/127; G11B 5/187

(52) U.S. Cl. 29/603.09; 29/603.1; 29/603.12; 29/603.18; 216/22

(57) ABSTRACT

The method of producing a head slider is capable of restraining variation of processing read-elements, forming the read-elements having a prescribed size, improving production yield and improving magnetoresistance characteristics. The method comprises the steps of: forming grooves in a wafer substrate, wherein the grooves correspond to raw bars to be cut from the wafer substrate; filling the grooves with an insulating material; forming read-elements and write-elements on the surface of the wafer substrate, whose grooves have been filled with the insulating material; and cutting the wafer substrate, on which the read-elements and the write-elements have been formed, along the grooves so as to form the raw bars, whose base members are constituted by the wafer substrate and coated with the insulating material.

### BACKGROUND OF THE INVENTION

The present invention relates to a method of producing a head slider, more precisely relates to a method of producing a head slider, which is capable of processing read-elements to have a prescribed size.

Head sliders are produced by the steps of: forming read-elements and write-elements on a surface of a wafer substrate, which is composed of, for example, ALTIC (Al₂O₃—TiC), by a film deposition process; cutting raw bars from the wafer substrate; processing air bearing surfaces of head sliders; and cutting the raw bar to form independent head sliders.

FIGS. 19A-25 show an outline of producing independent head sliders 20 from a wafer substrate 10.

FIG. 19A shows the wafer substrate 10, which is a base material of the head sliders 20. FIG. 19B is a sectional view of the wafer substrate 10 taken along a line A-A shown in FIG. 19A.

FIG. 20A shows the wafer substrate 10, on which element sections 12, each of which includes a read-element and a write-element, are formed by the film deposition process, etc.. A number of the element sections 12 are arranged in a matrix in a surface of the wafer substrate 10. FIG. 20B shows a layer including the read-elements 12a and a layer including the write-elements 12b, which are laminated on the wafer substrate 10.

In FIG. 21, the wafer substrate 10, on which the element sections 12 have been formed, is cut along array directions of the element sections 12 and divided into a plurality of blocks. Each of the blocks is a stack bar 14, in which a plurality of raw bars are included.

FIG. 22 shows a step of forming raw bars 16 from the stack bar 14. In this step, the stack bar 14 is adhered onto a support jig 15, which is composed of an electrically conductive ceramic, and an exposed sensing surface (an air bearing surface) of the stack bar 14 is abraded on an abrasive plate 17 so as to form sensing sections having a prescribed size.

The sensing sections are processed by abrading the exposed sensing surface of the raw bar 16 until heights of the read elements (MR height) reach a prescribed height. For example, the abrasion process is performed with monitoring resistance values of MR elements until the resistance values reach a prescribed value. Upon reaching the prescribed resistance value, the abrasion process is stopped.

After completing the abrasion process, the outermost raw bars 16 in the stack bar 14 is cut from the stack bar 14 and set on a setting plate 18 (see FIG. 23). A cut surface of the stack bar 14 is abraded every time the raw bar 16 is cut from the stack bar 14, and then the new outermost raw bar 16 is cut and set on the setting plate 18. These steps are repeated as shown in FIG. 24.

Next, step-shaped sections, which will be included in the air bearing surfaces of the head sliders, are formed in outer faces of the raw bars 16 set on the setting plate 18. In FIG. 24, the step-shaped sections are formed in the outer faces of the raw bars 16, which will be the air bearing surfaces of the head sliders.

Finally, the raw bar 16, in which the air bearing surfaces of the head sliders have been processed, is adhered to a ceramic tool 19 and cut to form the independent head sliders (see FIG. 25).

The above described conventional technology is disclosed in, for example, Japanese Patent Gazettes No. 2004-55028 and No. 2006-53999.

As described above, in the conventional method of producing the head slider, the raw bar is abraded until the heights of the read-elements (MR heights) reach the prescribed height. However, the conventional technology has following problems.

The MR heights are adjusted by abrading the entire raw bar 16. Even if the raw bar 16 is supported by the jig 15, the raw bar 16 is not always perfectly supported in a horizontal plane. If the raw bar 16 is waved in the height direction, the amount of abrading the raw bar 16 partially varied, so that the MR heights are partially varied in the raw bar 16.

In FIG. 22 which is an enlarged view, hardness of an ALTIC base member 10a of the raw bar 16 is quite different from that of materials of a read-element 12a and a write-element 12b, and an abrasion rate of the sensing section is greater than that of the base member 10a. Therefore, a step-shaped part is formed between the sensing section and the base member 10a, so a clearance between the sensing section and a surface of a storage medium cannot be shortened.

In the abrasion process, abrasive grains are used, so surfaces of the MR elements will be damaged. Further, smears will stick onto surfaces of the sensing sections during the abrasion process.

### SUMMARY OF THE INVENTION

The present invention was conceived to solve the above described problems.

An object of the present invention is to provide a suitable method of producing a method of producing a head slider, which is capable of restraining variation of processing read-elements, forming the read-elements having a prescribed size, improving production yield and improving magnetoresistance characteristics.

To achieve the object, the present invention has following constitutions.

Namely, the method of producing a head slider comprises the steps of: forming grooves in a wafer substrate, wherein the grooves correspond to raw bars to be cut from the wafer substrate; filling the grooves with an insulating material; forming read-elements and write-elements on the surface of the wafer substrate, whose grooves have been filled with the insulating material; and cutting the wafer substrate, on which the read-elements and the write-elements have been formed, along the grooves so as to form the raw bars, whose base members are constituted by the wafer substrate and coated with the insulating material.

For example, the step of forming the read-elements and the write-elements comprises the steps of: firstly forming the read-elements; removing disused parts of the read-elements, whose boundaries are defined by positions of a prescribed MR height of the read-elements, by etching, so as to form the read-elements having the prescribed MR height; and forming the write-elements. Since the MR height of the read-elements are set by etching, the MR height thereof can be highly precisely set and forming smears, which are formed by abrasion, etc., can be prevented.

For example, the read-elements having the prescribed MR height are formed by the steps of: forming a resist pattern, whose opening sections correspond to the read-elements, on a surface of a film layer, in which the read-elements have been formed; and etching the film layer with using the resist pattern as a mask until the MR heights of the read-elements reach the prescribed height. In this case, the MR height of the read-elements can have a prescribed height.

For example, the film layer is etched by the steps of: forming grooves in the film layer until reaching the surfaces of the insulating material filling the grooves formed in the wafer substrate; and filling the grooves formed in the film layer with an insulating material. In this case, in the raw bar, the base member and the film layer too are coated with the insulating material.

For example, the each of the raw bars, whose base member has been coated with the insulating material, is cut from the wafer substrate by the steps of: abrading an air bearing surface of the raw bar to leave a layer of the insulating material on the air bearing surface; and cutting the raw bar from the wafer substrate. By leaving the layer of the insulating material on the air bearing surface, falling particles of the base member of the wafer substrate from the air bearing surface of the head slider can be prevented.

The method may further comprise the step of dry-etching surfaces of the raw bars, whose base members have been coated with the insulating material, as a finishing step. In this case, flatness of the air bearing surface of the head slider can be improved.

Preferably, the dry-etching step is performed with measuring electric currents passing through the read-elements so as to detect a terminal point of removing the insulating material stuck on the film layer, in which the read-elements have been formed. In this case, the insulating material coating the read-elements can be securely removed.

Preferably, the dry-etching step is performed with measuring resistances of the read-elements, and the dry-etching step is stopped when the resistances reach a prescribed value. In this case, the insulating material sticking on the film layer, in which the read-elements are formed, can be removed, and the read-elements can be trimmed so as to have prescribed resistance.

In the production method of the present invention, the surface of the base member of the raw bar is coated with the insulating material when the raw bar is cut from the wafer substrate. Therefore, the air bearing surface of the raw bar is constituted by the homogenous insulating material, the abrasion process can be highly precisely performed, variation of processing the head slider can be restrained, and the high quality head slider can be produced.

### BRIEF DESCRIPTION OF THE DRAWINGS

Embodiments of the present invention will now be described by way of examples and with reference to the accompanying drawings, in which:

FIG. 1 includes a plan view of a wafer substrate, in which grooves are formed, and a sectional view thereof taken along a line A-A;

FIG. 2 includes a plan view of the wafer substrate, in which the grooves are filled with an insulating material, and a sectional view thereof taken along a line A-A;

FIG. 3 includes a plan view of the wafer substrate, in which read-elements are formed, and a sectional view thereof taken along a line A-A;

FIGS. 4A and 4B are explanation views showing steps of setting a MR height of the read-elements;

FIG. 5 includes a plan view of the wafer substrate, in which write-elements are formed, and a sectional view thereof taken along a line A-A;

FIG. 6 includes a plan view of stack bars cut from the wafer substrate, and a sectional view thereof taken along a line A-A;

FIG. 7 is an explanation view showing a step of forming a raw bar;

FIGS. 8A and 8B are explanation views showing steps of processing the raw bar;

FIG. 9 is an explanation view of etching the insulating material;

FIG. 10 is an explanation view of the read-element, in which the insulating material has been removed from a surface;

FIG. 11 is a perspective view of the raw bar;

FIG. 12 is a perspective view of the raw bar, whose air bearing surface is coated with a protection film;

FIG. 13 is a perspective view of the raw bar, in which a resist pattern is formed on the air bearing surface so as to form an air bearing surface section;

FIG. 14 is a perspective view of the raw bar, in which the air bearing surface section is formed in the air bearing surface;

FIG. 15 is a perspective view of the raw bar, in which a resist pattern is formed on the air bearing surface so as to form a step section;

FIG. 16 is a perspective view of the raw bar, in which the step section is formed in the air bearing surface;

FIG. 17 is a plan view of the wafer substrate, in which grooves arranged in a waffle pattern are filled with an insulating material;

FIG. 18 is a perspective view of a head slider;

FIG. 19A is a plan view of a wafer substrate, and FIG. 19B is a sectional view taken along a line A-A;

FIG. 20A is a plan view of the wafer substrate, in which element sections are formed, and FIG. 20B is a sectional view thereof taken along a line A-A;

FIG. 21 is a plan view of stack bars cut from the wafer substrate;

FIG. 22 is an explanation view showing the conventional step of forming a raw bar;

FIG. 23 is a plan view of a setting plate, on which the raw bars are set;

FIG. 24 is a plan view of the raw bars, whose air bearing surfaces have been processed; and

FIG. 25 is an explanation views showing a step of forming independent head sliders from the raw bar.

### DETAILED DESCRIPTION OF THE EMBODIMENTS

Preferred embodiments of the present invention will now be described in detail with reference to the accompanying drawings.

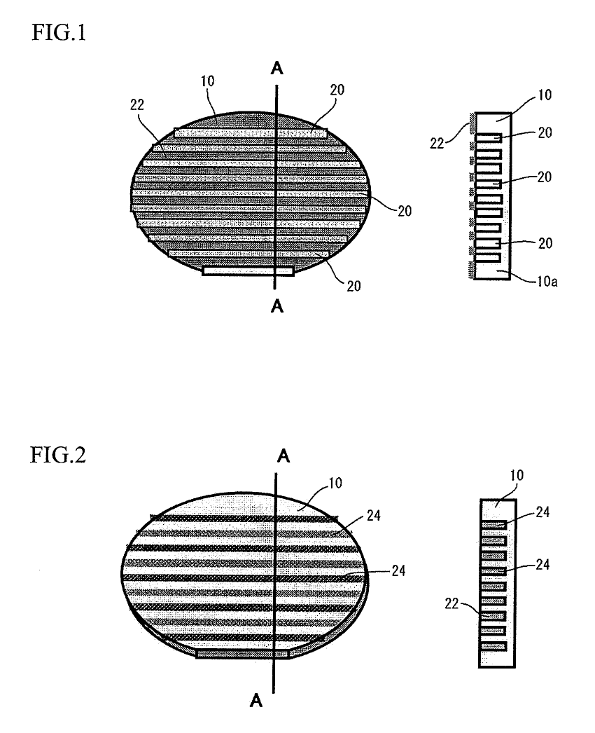

In FIG. 1, grooves 20 are formed in a wafer substrate 10, which is composed of ALTIC (Al₂O₃—TiC), by suitable means, e.g., cutting means, laser means. The grooves 20 are placed to correspond to raw bars to be formed, and they are extended and arranged parallel in the longitudinal direction of the raw bars. For example, each of the grooves 20 is formed on the air bearing surface side of each of the raw bars. A number of the raw bars will be formed parallel in the wafer substrate 10, so each of the grooves 20 is formed between the adjacent raw bars. A width of the grooves 20 is about several tens of μm.

As shown in a sectional view of FIG. 1 taken along a line A-A, the raw bars will be cut in the thickness direction of the wafer substrate 10, so that one of cut surfaces of each of the raw bars will be an air bearing surface. In the process of forming the grooves 20, a depth of each of the grooves 20 is made greater than a length of a head slider (an anteroposterior length of the head slider or a direction of streaming air on the air bearing surface).

The grooves 20 are filled with an insulating material, e.g., alumina. In the present embodiment, firstly a surface of the wafer substrate 10 is coated with resist 22, and then the grooves 20 are formed in a base member 10a of the wafer substrate 10 together with the resist 22. In another case, the grooves 20 may be formed by the steps of: coating the surface of the wafer substrate 10 with the resist 22; optically exposing and developing the resist 22 so as to form a resist pattern, in which parts corresponding to the grooves 20 are opened; and forming the grooves 20 in the opened parts of the resist pattern.

In FIG. 2, the grooves 20 are filled with an insulating material 24, e.g., alumina, by sputtering. The resist has been removed after filling the grooves 20 with the insulating material 24.

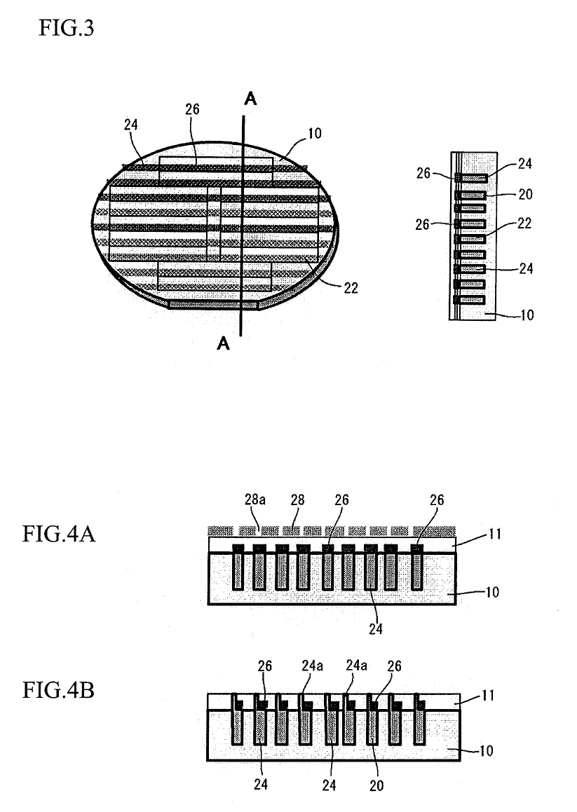

In FIG. 3, read-elements 26 are formed on the surface of the wafer substrate 10. The read-elements 26 are formed by a known method. Namely, the read-elements 26 are formed by laminating magnetic films, insulating films, etc. on the surface of the wafer substrate 10. Each of the read-elements 26 is formed for each of the head sliders. In FIG. 3, positions of the read-elements 26 correspond to the raw bars to be formed in the wafer substrate 10. One line of the read-elements 26 correspond to one raw bar. In each of the head sliders, the read-element 26 is provided a position close to the air bearing surface. Thus, as shown in a sectional view of FIG. 3 taken along a line A-A, the read-elements 26 are respectively formed on the insulating material 24 filling the grooves 20.

FIGS. 4A and 4B show the steps of processing the read-elements 26 to have a prescribed size. The present embodiment is characterized in that the size, i.e., a MR height, of the read-elements 26 is determined in the process stage of forming the read-elements 26.

To form the read-elements 26 having the prescribed size, firstly the surface of the wafer substrate 10 is coated with resist 28, and then the resist is optically exposed and developed, by a high performance photolithography apparatus, so as to form opening sections 28a at prescribed positions, at which the read-elements 26 will be etched or partially removed.

Each of the opening sections 28a of the resist 28 is formed to traverse the read-element 26, and an end face of each of the opening sections 28a is set to define an end face of each of the read-elements 26 partially etched. Actually, the resist 28 is patterned so as to form each of the opening sections 28a, which corresponds to a position for etching the read-elements 26 and traverses each of the raw bars in the longitudinal direction.

Next, the read-elements 26 are etched, with using the patterned resist 28 as a mask, until the etched grooves reach upper faces of the insulating material 24 filling the grooves 20. With this step, the MR heights of the read-elements 26 are determined. By etching the read-elements 26, grooves are formed in a film layer 11, in which magnetic layers, insulating layers, etc. are laminated.

Next, the resist 28 is removed, and then the grooves formed in the film layer 11 are filled with an insulating material 24a, which is the same as the insulating material 24 filling the grooves 20. For example, in case of using alumina as the insulating material 24, the grooves formed in the film layer 11 are filled with alumina by sputtering. By filling the grooves with the insulating material 24a, the insulating material 24a projects a surface of the film layer 11, so the surface of the wafer substrate 10 is flattened by a chemical mechanical polishing method.

In FIG. 4B, the surface of the wafer substrate 10 is flattened. The grooves 20 in the wafer substrate 10 are filled with the insulating material 24; the grooves formed in the thickness direction of the film layer 11 formed on the surface of the wafer substrate 10 are filled with the insulating material 24a.

In FIG. 5, write-elements 30 are formed on the wafer substrate 10, on which the read-elements 26 have been already formed. The write-elements 30 are formed at positions, each of which corresponds to the read-element 26. The write-elements 30 too are formed by a known method.

In the former step, the surface of the wafer substrate 10 has been abraded and flattened. Magnetic layers, insulating layers and coils are formed in prescribed patterns so as to form the write-elements 30. In a sectional view of FIG. 5, the layer including the read-elements 26 is formed on the base member 10a of the wafer substrate 10, and the layer including the write-elements 30 is formed on the layer including the read-elements 26.

After forming the write-elements 30, a rear surface of the wafer substrate 10 is abraded so as to determine the length of the head sliders. As described above, the depth of the grooves 20 is greater than the length of the head sliders. So, in this step, the wafer substrate 10 is abraded beyond bottom faces of the grooves 20 formed in the wafer substrate 10.

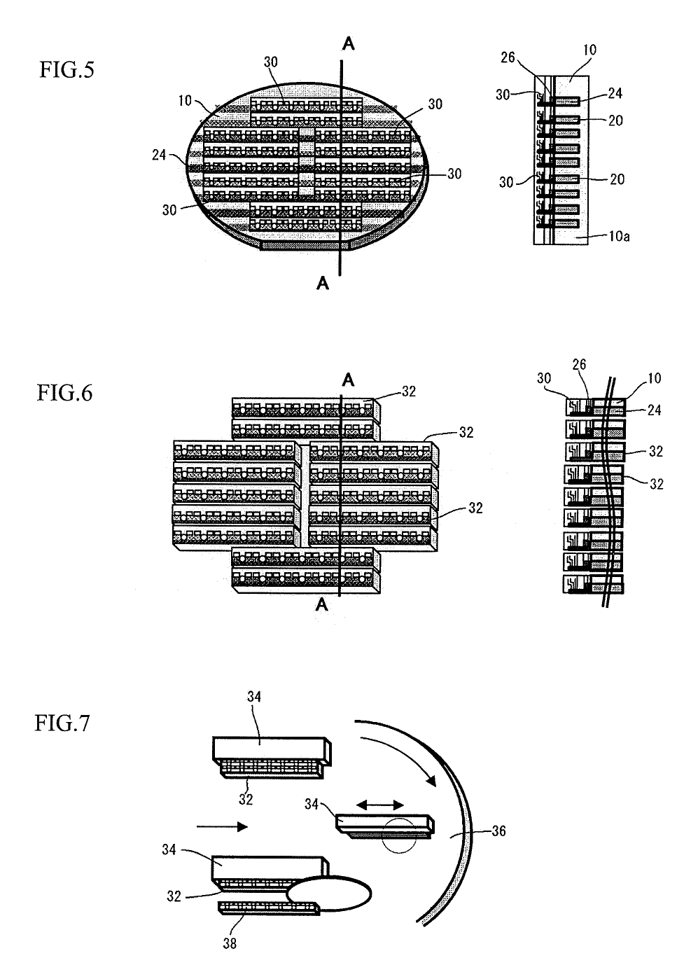

In FIG. 6, stack bars 32, in each of which a plurality of the raw bars are integrated, are cut from the wafer substrate 10. When the stack bars 32 are formed, the wafer substrate 10 is cut along the grooves 20.

In a sectional view of FIG. 6, one raw bar is included in the stack bar 32, but a plurality of the raw bars are integrally piled in the actual stack bar 32.

FIG. 7 shows a step of cutting the raw bars 38 from the stack bar 32. The stack bar 32 is adhered to and supported by a supporting jig 34, which is composed of an electrically conductive ceramic, and the stack bar 32 is abraded by an abrasive plate 36, but a layer of the insulating material is left on an air bearing surface of the stack bar 32 (raw bar 38). After abrading the air bearing surface of the stack bar 32, the raw bar 38 is cut from the stack bar 32.

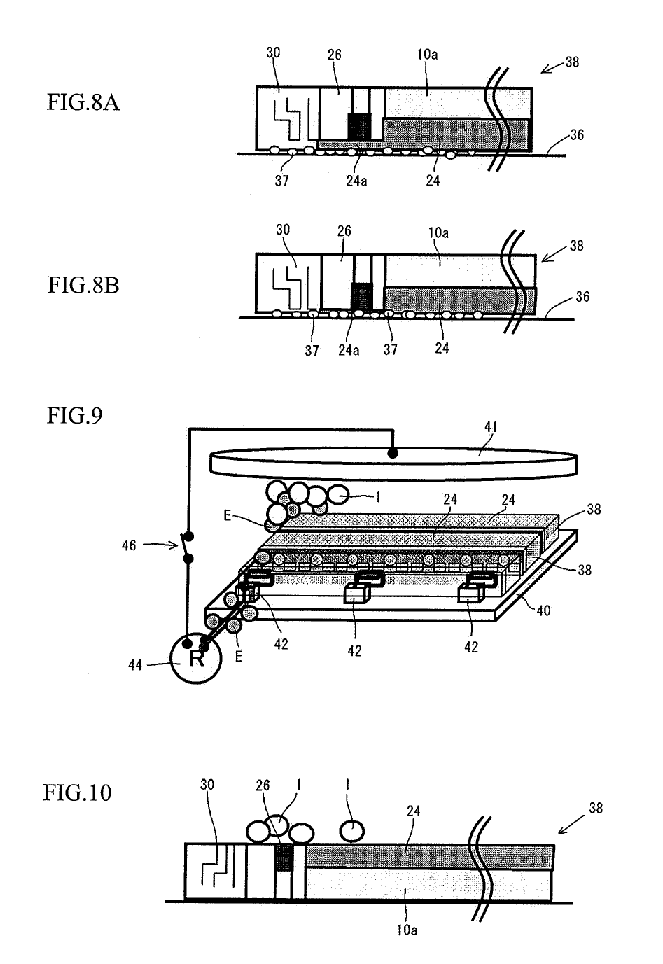

FIGS. 8A and 8B are enlarged explanation views, wherein one raw bar 38 in the stack bars 32 is abraded.

FIG. 8A shows the raw bar 38 whose air bearing surface is not abraded. When the stack bar 32 is cut from the wafer substrate 10, the wafer substrate 10 is cut along the groove 20. Concretely, the wafer substrate 10 is cut along a line corresponding to end faces of disused parts, which are located on the other side of the read-elements 26 in the groove 20. The insulating material 24 filling the groove 20 and the insulating material 24a filling the layer including the read-elements 26, which is formed on the wafer substrate 10, are exposed in the air bearing surface of the raw bar 38.

By abrading the rear surface of the wafer substrate 10, the entire surface of the base member 10a on the air bearing surface side are coated with the insulating material 24, and the parts of the read-elements 26 are coated with the insulating material 24a.

In the present embodiment, after cutting the stack bar 32 from the wafer substrate 10, the air bearing surface of the stack bar 32, which will be abraded, is coated with the insulating materials 24 and 24a, e.g., alumina. Therefore, the air bearing surface of the stack bar 32 has even hardness. In the layer including the write-elements 30, magnetic layers and insulating layers composed of, for example, alumina are laminated, and hardness of the layer including the write-elements 30 is not significantly different from that of the insulating materials 24 and 24a.

Therefore, unlike abrading the air bearing surface of the conventional stack bar (raw bar), the hardness of the air bearing surface of the stack bar 32 is even and lower than that of ALTIC, so that the air bearing surface of the stack bar 32 can be abraded, by the chemical mechanical polishing method, with using fine abrasive grains 37, e.g., silica.

In FIG. 8B, the stack bar 32 (raw bar 38) has been abraded. The abrasion process is performed until the insulating material 24a is slightly left on the surface of the layer including the read-elements 26. By using the fine abrasive grains 37, damaging the air bearing surfaces of the raw bar 38 can be prevented, remaining stress in the raw bar 38 can be prevented and the air bearing surface can be highly precisely abraded. Since the air bearing surface of the raw bar 38 is composed of the homogenous insulating materials 24 and 24a, the entire raw bar 38 can be evenly abraded and forming the step-shaped parts, which are formed between the base member and the element sections of the conventional raw bar, can be prevented. Further, forming smears during the abrasion process can be restrained.

After abrading the air bearing surface of the stack bar 32, the outermost raw bar 38 is cut from the stack bar 32, and then the new outermost raw bar 38 of the stack bar 32, which has been adhered to and supported by the support jig 34, is abraded again. Namely, the process of abrading the outermost raw bar 38 and the process of cutting the outermost raw bar 38 from the stack bar 32 are repeated in order, so that the raw bars 38, whose air bearing surfaces have been abraded, can be obtained.

As shown in FIG. 8B, in the obtained raw bar 38, the surface of the base member 10a of the wafer substrate 10 on the air bearing surface side is coated with the insulating material 24, and the insulating material 24a is slightly stuck on the read-elements 26.

FIG. 9 shows the next step, wherein the insulating material 24a, e.g., alumina, slightly stuck on the read-elements 26 in the raw bar 38 is removed.

To remove the insulating material 24a, a reactive ion etching (RIE) method is used in the present embodiment as an example of a dry etching method. As shown in FIG. 9, the raw bars 38, whose air bearing surfaces coated with the insulating materials 24 and 24a are faced upward, are set on an electrode plate 40 of a RIE apparatus, and then high-frequency voltage is applied between the electrode plate 40 and an electrode 41 so as to etch the insulating materials 24a.

Purposes of the etching process is to remove the insulating material 24a from the surface including the read-elements 26 and to monitor resistance values of the read elements 26 and equalize the resistance values, so that the final MR height of the read-elements 26 can be determined.

Therefore, terminals 42 connected to the read-elements 26 are provided to each of the raw bars 38, and a resistance measuring equipment is connected to the terminals 42 of each of the raw bars 38. A terminal point detecting equipment 46 stops generating plasma when the insulating materials 24a are removed and the resistance values of the read-elements 26 reach a prescribed value (i.e., the MR heights of the read-elements 26 reach a prescribed MR height).

By generating plasma in the RIE apparatus, metal etching ions I and electrons E are generated therein. At the beginning of the etching process, the surfaces of the read-elements 26 are coated with the insulating materials 24a, so no current passes through the read-elements 26 and the resistance measuring equipment 44 measures no resistance of the read-elements 26. With the progress of the etching, the insulating materials 24a coating the read-elements 24a are gradually removed and ion currents can pass through the read-elements 26, so that the resistance measuring equipment 44 can measure resistance values of the read-elements 26. When the ion currents are increased with progressing the etching, the resistance measuring equipment 44 can correctly measure resistance values of the read-elements 26. When the resistance values reach the prescribed value, the terminal point detecting equipment 46 stops the etching.

The resistance of the read-elements 26 can be measured when the insulating materials 24a stuck on the read-elements 26 are removed and the increased ion currents pass through the read-elements 26 as shown in FIG. 10. Further, the resistance values (MRR) are increased with etching the read-elements 26, so the read-elements 26 can be trimmed until reaching the prescribed MR height or the prescribed resistance value.

Namely, by performing the etching process shown in FIG. 9, completely removing the insulating materials 24a from the read-elements 26 can be known, and the read-elements 26 can be trimmed so as to equalize the MR heights or the resistance values of the read-elements 26.

Note that, the resistance values of the read-elements 26 may be equalized by the steps of: removing the insulating materials 24a by the RIE apparatus; and then abrading the read-elements 26, by the known method, until the resistance values of the read-elements 26 reach the prescribed value. In this case, the ion currents passing through the read-elements may be detected by, for example, an ammeter while etching the insulating materials 24a by the RIE apparatus so as to detect the terminal points of removing the insulating materials 24a, and the etching may be stopped when the terminal points are detected. In the present embodiment too, the abrasion is executed with monitoring the resistance values of the read-elements 26 as well as the conventional method. Since the entire air bearing surface of the raw bar 38 is coated with the insulating material 24, the abrasion process for determining the heights of the read-elements 26 can be precisely controlled.

After removing the insulating materials 24a and trimming the read-elements 26, step-shaped sections (ABS sections and STEP sections) are formed in the air bearing surface of the head slider.

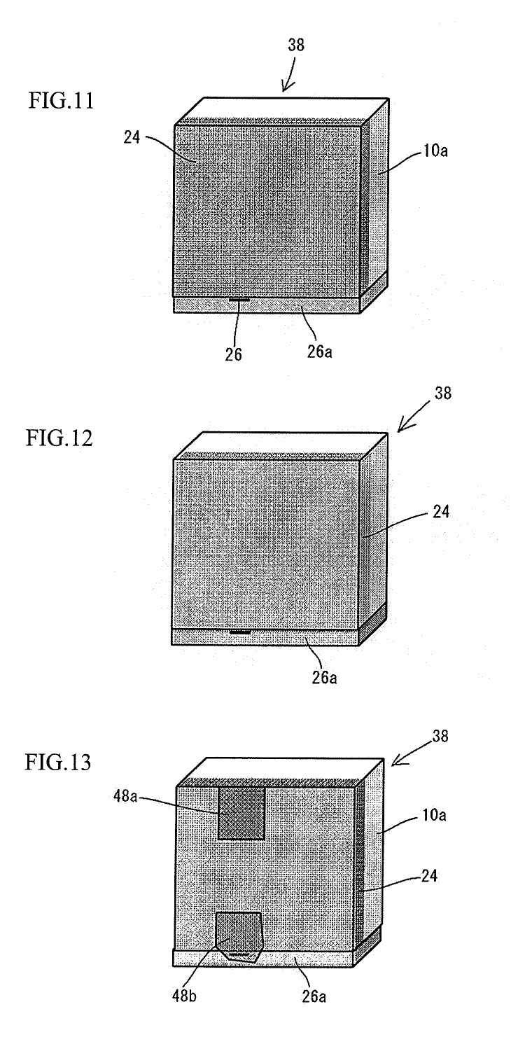

FIGS. 11-16 show the steps of processing the air bearing surfaces of the head sliders. Note that, FIGS. 11-16 are enlarged perspective views of one of the head sliders included in the raw bar 38.

FIG. 11 shows the surface of the raw bar 38, which faces a storage medium. The surface of the base member 10a of the wafer substrate 10 is coated with the insulating material 24, e.g., alumina. An element layer 26a including the read-elements 26 is formed on the bottom face of the raw bar 38.

FIG. 12 shows the raw bar 38 whose surface is coated with a protection film. The protection film is composed of, for example, diamond-like carbon (DLC).

In FIG. 13, resist 48a and 48b are patterned so as to form the ABS sections (highest step-shaped sections in the air bearing surface). The resist patterns correspond to the planar shapes of the ABS sections.

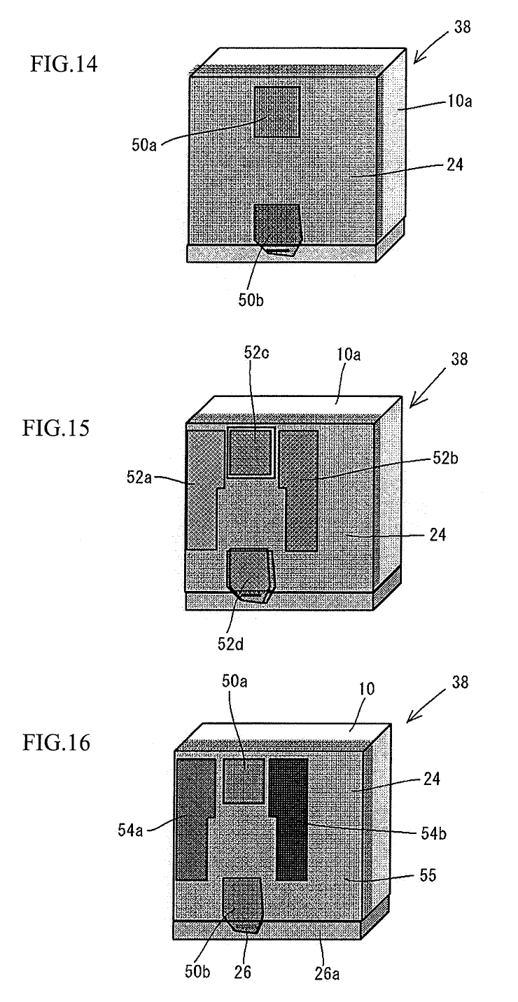

In FIG. 14, the raw bar 38 is ion-milled, with using the resist 48a and 48b as masks, so as to form the ABS sections 50a and 50b. In this ion-milling step, the surface of the raw bar 38 is etched until reaching heights of the STEP sections, which are one step lower than the ABS sections. Since the surface of the raw bar 38 is coated with the insulating material 24, the insulating material 24 is actually etched. After removing the resist 48a and 48b, the ABS sections 50a and 50b are formed into the step-shaped sections one step higher than outer regions thereof.

In FIG. 15, resist patterns 52a and 52b, which correspond to planar shapes of the STEP sections, are formed so as to form the STEP sections. To protect the ABS sections 50a and 50b while forming the STEP sections, resist patterns 52c and 52s are formed on the ABS sections 50a and 50b.

In FIG. 16, the STEP sections 54a and 54b are formed, by ion milling, with using the resist patterns 52a-52d as masks. By the ion milling, peripherals of the ABS sections 50a and 50b and the STEP sections 54a and 54b become a lower region 55, which is one step lower than the STEP sections 54a and 54b. The ABS sections 50a and 50b are one step higher than the STEP sections 54a and 54b.

After forming the ABS sections 50a and 50b and the STEP sections 54a and 54b in the air bearing surface, the raw bar 38 is adhered to and supported by the ceramic tool 19 as shown in FIG. 25, and then the raw bar 38 is cut to form the independent head sliders.

In each of the independent head sliders, the air bearing surface is coated with the insulating material 24, and the insulating material 24 is etched to form the ABS sections 50a and 50b and the STEP sections 54a and 54b in the air bearing surface.

By coating the air bearing surface with the insulating material 24, no base member 10a of the wafer substrate 10, which is composed of ALTIC, is exposed in the air bearing surface, so that falling particles of the base member 10a of the wafer substrate 10 from the air bearing surface can be prevented.

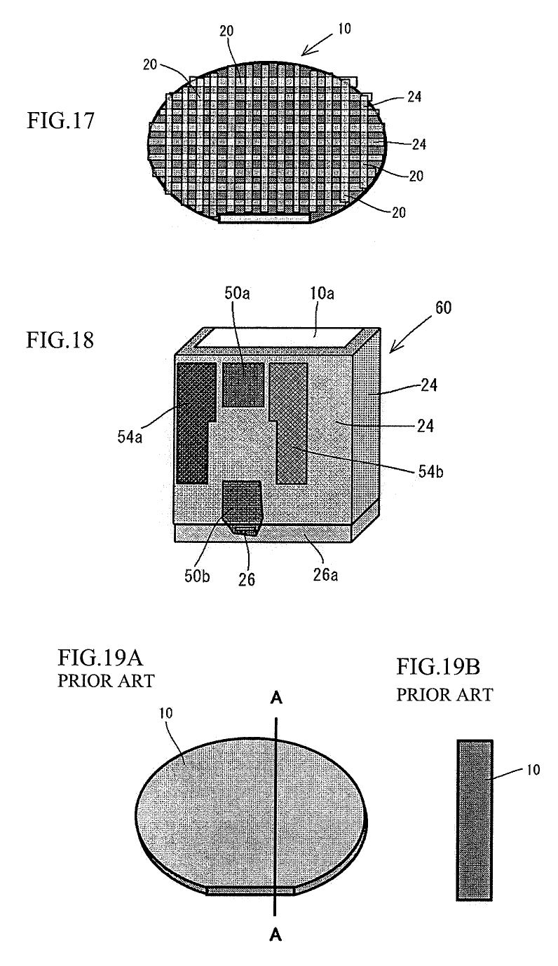

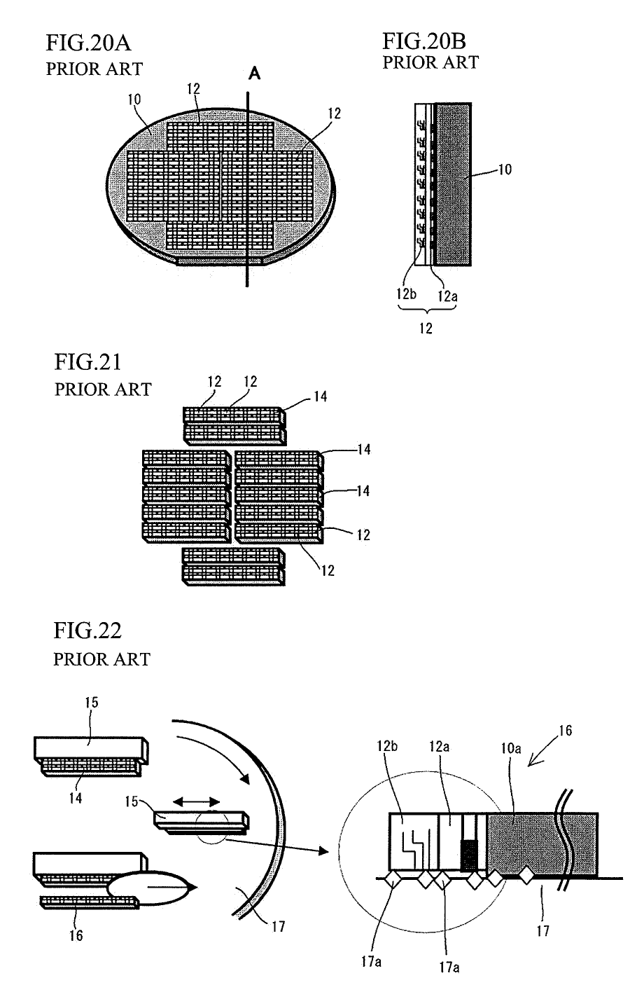

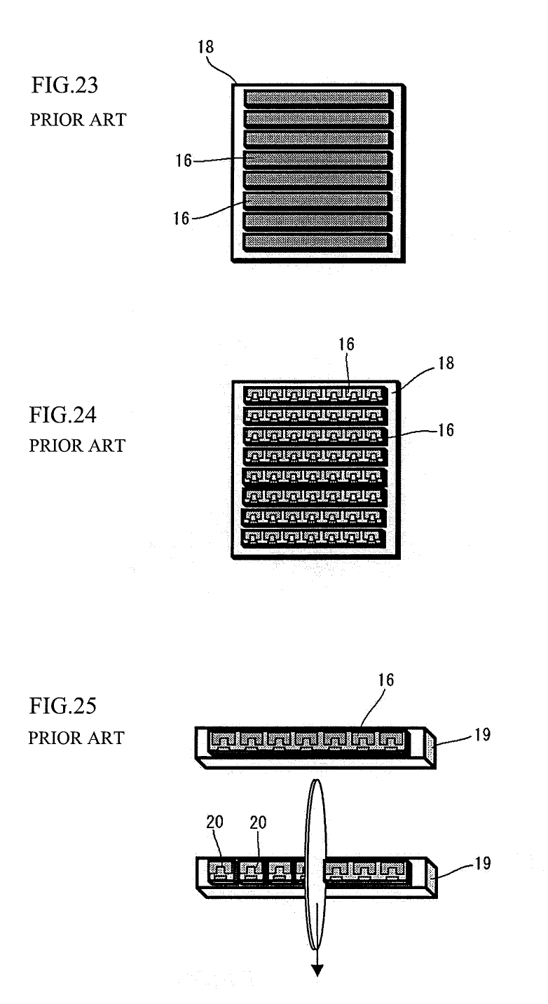

In case of coating side faces of the independent head slider with an insulating material, e.g., alumina, the grooves 20 of the wafer substrate 10 are formed to correspond to the air bearing surfaces of the head sliders, and further grooves 20 are formed to correspond to side faces of the head sliders as shown in FIG. 17. By filling all of the grooves 20 with the insulating material, e.g., alumina, the air bearing surface and the side faces of the independent head slider can be coated with the insulating material.

FIG. 18 shows the independent head slider 60 cut from the raw bar. The side faces of the head slider 60 are coated with the independent material 24. By coating the side face of the head slider 60 with the insulating material 24, falling particles of the base member 10a of the wafer substrate 10 from the side faces can be prevented. Therefore, disk crush, which is caused by ALTIC particles fallen onto a surface of the storage medium, can be prevented.

Unlike the conventional method in which the read-elements are abraded, the method of the above described embodiment is capable of highly accurately determining the heights of the read-elements 26 by etching. The air bearing surface of the raw bar, which is substantially evenly coated with the insulating material, is abraded, so that the abrasion process can be performed with high accuracy. Further, variation of abrasion can be prevented, so that no step-shaped parts are formed between the base members and the sensing sections of the head sliders. Therefore, an amount of floating the sensing section from the surface of the storage medium can be restrained, and electromagnetic conversion characteristics of the head slider can be improved.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a head slider,
comprising the steps of:
forming grooves in a wafer substrate, wherein the grooves correspond to raw bars to be cut from the wafer substrate;
filling the grooves with an insulating material;
forming read-elements and write-elements on the surface of the wafer substrate, whose grooves have been filled with the insulating material; and
cutting the wafer substrate, on which the read-elements and the write-elements have been formed, along the grooves so as to form the raw bars, whose base members are constituted by the wafer substrate and coated with the insulating material.

2. The method according to claim 1,
wherein the step of forming the read-elements and the write-elements comprises the steps of:
firstly forming the read-elements;
removing disused parts of the read-elements, whose boundaries are defined by positions of a prescribed MR height of the read-elements, by etching, so as to form the read-elements having the prescribed MR height; and
forming the write-elements.

3. The method according to claim 2,
wherein the read-elements having the prescribed MR height are formed by the steps of:
forming a resist pattern, whose opening sections correspond to the read-elements, on a surface of a film layer, in which the read-elements have been formed; and
etching the film layer with using the resist pattern as a mask until the MR heights of the read-elements reach the prescribed height.

4. The method according to claim 3,
wherein the film layer is etched by the steps of:
forming grooves in the film layer until reaching the surfaces of the insulating material filling the grooves formed in the wafer substrate; and
filling the grooves formed in the film layer with an insulating material.

5. The method according to claim 1,
wherein the each of the raw bars, whose base member has been coated with the insulating material, is cut from the wafer substrate by the steps of:
abrading an air bearing surface of the raw bar to leave a layer of the insulating material on the air bearing surface; and
cutting the raw bar from the wafer substrate.

6. The method according to claim 2,
wherein the each of the raw bars, whose base member has been coated with the insulating material, is cut from the wafer substrate by the steps of:
abrading an air bearing surface of the raw bar to leave a layer of the insulating material on the air bearing surface; and
cutting the raw bar from the wafer substrate.

7. The method according to claim 3,
wherein the each of the raw bars, whose base member has been coated with the insulating material, is cut from the wafer substrate by the steps of:
abrading an air bearing surface of the raw bar to leave a layer of the insulating material on the air bearing surface; and
cutting the raw bar from the wafer substrate.

8. The method according to claim 4,
wherein the each of the raw bars, whose base member has been coated with the insulating material, is cut from the wafer substrate by the steps of:
abrading an air bearing surface of the raw bar to leave a layer of the insulating material on the air bearing surface; and
cutting the raw bar from the wafer substrate.

9. The method according to claim 1,
further comprising the step of dry-etching surfaces of the raw bars, whose base members have been coated with the insulating material, as a finishing step.

10. The method according to claim 2,
further comprising the step of dry-etching surfaces of the raw bars, whose base members have been coated with the insulating material, as a finishing step.

11. The method according to claim 3,
further comprising the step of dry-etching surfaces of the raw bars, whose base members have been coated with the insulating material, as a finishing step.

12. The method according to claim 4,
further comprising the step of dry-etching surfaces of the raw bars, whose base members have been coated with the insulating material, as a finishing step.

13. The method according to claim 9,
wherein the dry-etching step is performed with measuring electric currents passing through the read-elements so as to detect a terminal point of removing the insulating material stuck on the film layer, in which the read-elements have been formed.

14. The method according to claim 10,
wherein the dry-etching step is performed with measuring electric currents passing through the read-elements so as to detect a terminal point of removing the insulating material stuck on the film layer, in which the read-elements have been formed.

15. The method according to claim 11,
wherein the dry-etching step is performed with measuring electric currents passing through the read-elements so as to detect a terminal point of removing the insulating material stuck on the film layer, in which the read-elements have been formed.

16. The method according to claim 12,
wherein the dry-etching step is performed with measuring electric currents passing through the read-elements so as to detect a terminal point of removing the insulating material stuck on the film layer, in which the read-elements have been formed.

17. The method according to claim 9,
wherein the dry-etching step is performed with measuring resistances of the read-elements, and
the dry-etching step is stopped when the resistances reach a prescribed value.

18. The method according to claim 10,
wherein the dry-etching step is performed with measuring resistances of the read-elements, and
the dry-etching step is stopped when the resistances reach a prescribed value.

19. The method according to claim 11,
wherein the dry-etching step is performed with measuring resistances of the read-elements, and
the dry-etching step is stopped when the resistances reach a prescribed value.

20. The method according to claim 12,
wherein the dry-etching step is performed with measuring resistances of the read-elements, and
the dry-etching step is stopped when the resistances reach a prescribed value.
